(19) United States
(12) Patent Application Publication
(10) Pub. No.: US 2014/0025507 A1
(43) Pub. Date: Jan. 23, 2014

(54) REAL-TIME ELECTRONIC DISPLAY SYSTEM

(71) Applicant: Robert Stephen Rogener, Studio City, CA (US)

(72) Inventor: Robert Stephen Rogener, Studio City, CA (US)

(21) Appl. No.: 13/946,305

(22) Filed: Jul. 19, 2013

Related U.S. Application Data
(60) Provisional application No. 61/673,847, filed on Jul. 20, 2012.

(51) Int. Cl. G06Q 30/02; G09G 5/00

(52) U.S. Cl. CPC G06Q 30/0269; G09G 5/006
USPC 705/14.66; 345/501; 345/156

(57) ABSTRACT

A real-time electronic, public display system, offered by a company, that is portable and mountable on a stanchion that can provide immediate and dynamic, 2-way communication that is useful to customers as well as the company. The system comprises a terminal, a housing, a processor located inside the housing, a solar power panel, a digital screen for displaying information, one or more external speakers, a power line harness conduit and a stanchion insert connector connected to the power line harness conduit. The invention describes how any paired technology, including any combination of NFC, WiFi, or Bluetooth NFC can facilitate wireless, targeted, and customized interaction for customers waiting in queues, while providing the company with a dashboard that controls offerings and communications.

### PRIORITY INFORMATION

This application claims priority to provisional patent application Ser. No. 61/673,847 filed on Jul. 20, 2012, the contents of which are incorporated herein by reference.

### FIELD OF THE INVENTION

The present invention relates to electronic displays, and more specifically to a real-time electronic display system that is portable and mountable on a stanchion that can provide immediate information useful to a customer.

### BACKGROUND

There are many electronic displays used currently, from gas stations to grocery stores. Most of these display systems are designed to provide remote access for operators to change prices and other information. However, most of these systems are static and immobile. For example, the QThru technology provides supermarket shoppers with a way to use their cell phones to calculate how much they've spent and what quantities of items they have purchased, or are going to purchase, by displaying QR codes electronically next to the product. While useful, the system is limited to providing nothing more than a static replacement for traditional printed signs, albeit at a much higher price. Other technology only provides information to a customer if they are at a kiosk.

In many situations, it is not possible to have electronic displays available to either provide information to customers regarding real-time events. Such as, for example, airport check-in queues and car rental check-in queues are dynamic and change many times during the day. The current available static displays are only useful if they are placed where customer can see them at all times. This requires many more large static signs at a greater cost. Additionally, these signs can only provide a limited amount of information.

Therefore, there is a need for a real-time electronic display system that is portable and mountable on a stanchion that can provide immediate information useful to a customer and provide a company with dashboard metrics.

### SUMMARY OF THE INVENTION

The invention is a real-time electronic display device that is portable and mountable on a stanchion that can provide immediate information useful to a customer. The device comprises a housing, a processor located inside the housing, a solar power panel connected to the housing, and a digital screen connected to the housing. The display screen is between 5 inches and 7.5 inches. The device also comprises one or more external speakers connected to the housing, a power line harness conduit connected to the housing, and a stanchion insert connector connected to the power line harness conduit. The stanchion can be connected to the stanchion insert connector and a base can be connected to the stanchion opposite the stanchion insert connector. Additionally, the device can comprise a fragrance dispenser outlet connected to the housing.

The device can be powered by a power cord and a power regulator is connected to the housing. The power regulator can convert standard electrical power to power that can be used by the device without overloading the device. Alternatively, the device can be powered by a battery. One battery option is a high capacity rechargeable battery. The battery used to power the device is connected to the housing.

One or more module cavities are connected to the housing, and one or more keyed device input modules are connectable to the module cavities. The module cavities can be configured to accept keyed modules, and the keyed modules can perform various functions controlled by the device. The keyed device input module can be selected from the group consisting of a contactless NFC reader board, an arm based computer, a Wi-Fi module, a Bluetooth module, a processor module, a fragrance synthesizer module, a coupon module, and a ticketing module.

The device can also comprise instructions executable on the processor to identify each of the one or more keyed modules to automatically determine the functionality of the module and how to display information related to the model on the display screen to be presented to the customer.

The customer can use the device by entering a retail store that uses wireless communications and establishing communications with the real-time electronic display device. The device then measures a time from the establishment of communications between the customer and the device and transmits information from a customer from the device through a standard communications means to a processing system/company dashboard metric. The device then reviews all customer footprints available to the processing system to find the best offer available for the customer based on previous customer data, and compares industry specific variables related to offerings with the previous customer data, where the industry specific variables related to offerings can comprise fleet availability, weather and roadway information, seat utilization and baggage capacity, excess inventory and profit margins. Using that information, the device then determines an optimum offer for the customer and prepares a personalized offer to the customer using an offer management module. The device presents the customer value proposition to the customer's portable electronic device and the customer redeems the customer value proposition upon exiting the queue.

The customer's footprint can comprise a walk-in, a mobile application, a website or social media, a mobile website, a tablet, an 800 number, a promotion code, a third party website affiliate and a loyalty program. The previous customer data can comprise purchase history, loyalty program, and relevant historical data.

The offers presented to the customer can comprise upgrade offers, discount offers, personalized offers, social interaction, branded sweepstakes, dynamic and digital coupons, local offers, traditional coupons, video downloads, surveys, important notices, messages, application downloads, branded game download and scent offerings.

The device can be used by either a customer or a company by providing a real-time electronic display device, transmitting customer information from a processing system to the real-time electronic display device and to a customer's portable electronic device and transmitting information gathered from the customer from the real-time electronic display device to a central server for processing and displaying dashboard metrics. The device then determines pertinent offers and other information based on the received customer information and transmits the pertinent offers and other information to the customer, which allows the customer to interactively select products and items of interest while waiting to be served.

The real-time electronic display device can comprise a computing module for executing instructions for the system without the central server.

The device can provide information useful to a customer by establishing communications with a customer's portable electronic device and storing a customer ID and a device ID to track the customer's portable electronic device through the queue. The device can send a request to the customer's portable electronic device for input from the customer regarding offers, request the customer's interest input and then combine the input with the company's dashboard metrics. The device then streams appropriate offer information and queue information to the customer's portable electronic device. The device can also determine if the customer's portable electronic device is still in the queue by tracking the customer ID and the device ID to determine a location of the customer's portable electronic device in the queue. If it is determined that the device is still in the queue, then the device will present more offers while the customer's portable electronic device is still in the queue, while storing in a storage the customer ID and any information provided by the customer and data mining the stored information.

Alternatively, the device can stream only queue information to the customer and store time metrics for data mining.

### BRIEF DESCRIPTION OF THE DRAWINGS

These and other features, aspects and advantages of the present invention will become better understood with regard to the following description, appended claims, and accompanying figures where:

FIG. 1 is a front isometric view of a real-time electronic display device that is portable and mountable on a stanchion that can provide immediate information useful to a customer, according to one embodiment.

FIG. 2 is a rear isometric view of the device of FIG. 1;

FIG. 3 is a top view of the system of FIG. 1;

FIG. 4 is a front view of the device of FIG. 1;

FIG. 5 is a rearview of the device of FIG. 1;

FIG. 6 is a diagram of a stanchion useful for the device of FIG. 1;

FIG. 7 is a bottom view of a diagram of a base useful for the device of FIG. 1;

FIG. 8 is a top view of a diagram of a base useful for the device of FIG. 1;

FIG. 9 is a flowchart diagram of a rental booking system using the device of FIG. 1, according to one embodiment;

FIG. 9 is a flowchart diagram of a method using the device of FIG. 1, according to one embodiment;

FIG. 10 is a diagram of a person waiting in a queue using the information provided by the device of FIG. 1 and the system of FIG. 9; and

FIG. 11 is a flowchart diagram of another method for using the device 100.

### DETAILED DESCRIPTION

The present invention overcomes the limitations of the prior art by providing a real-time electronic display device that is portable and mountable on a stanchion that can provide immediate information useful to a customer as well as providing companies with measurable metrics within a dashboard. As can be appreciated, the present invention can empower companies to monetize captive audiences waiting in queues by utilizing emerging technologies, such as, NFC, RFID, Wi-Fi, Bluetooth, QR codes, synthesized scents, dynamic ticketing, dynamic couponing and digital video by providing real-time 2-way communication applicable to the captive audience. However, it is understood that other, newer, communications technologies can also be used with the device. Therefore, this disclosure is made by way of example and is not intended to be limiting regarding the communications technologies.

The system, using the device, enables customers to connect with companies, brands, retailers, friends and results in a unique and novel communication between companies and customers. While customers are in a queue, they can engage with companies through the device using their mobile phone or tablet or other connectable devices.

Systems, methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

Various embodiments provide a real-time electronic display system that is portable and mountable on a stanchion that can provide immediate information useful to a customer. In one embodiment, there is provided a system for a real-time electronic display device that is portable and mountable on a stanchion that can provide immediate information useful to a customer. In another embodiment of the present invention there is provided executable instructions operable on a processor for operating a real-time electronic display device that is portable and mountable on a stanchion that can provide immediate information useful to a customer. In another embodiment, there is provided a method for using the system. The system, methods and devices will now be disclosed in detail.

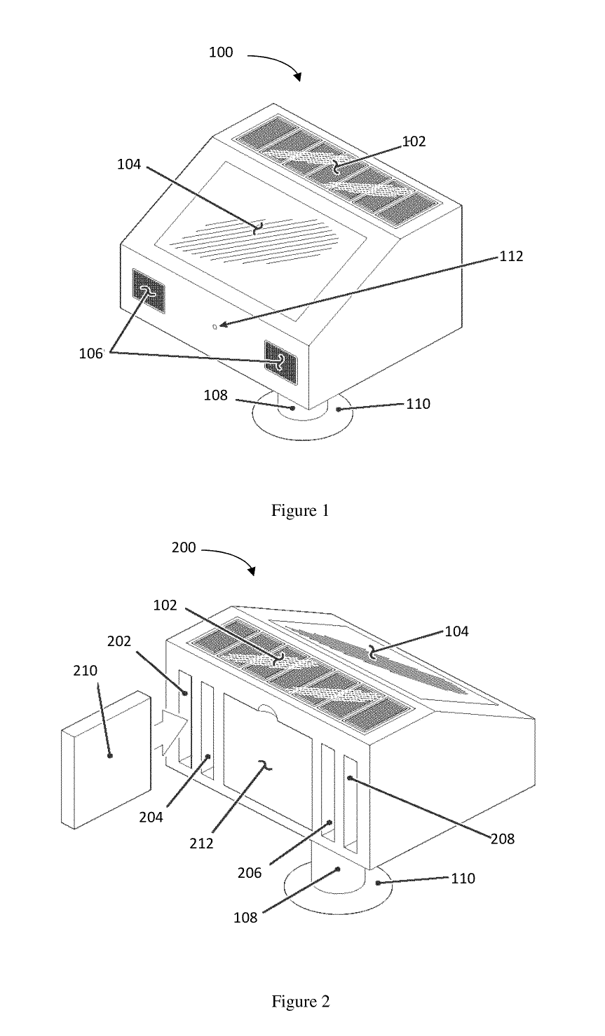

Referring now to FIG. 1, there is shown a front isometric view of a real-time electronic display device 100 that is portable and mountable on a stanchion that can provide immediate information useful to a customer, according to one embodiment. As can be seen, the device comprises a solar power panel 102, a digital screen 104, one or more external speakers 106, a power line harness conduit 108, and a stanchion insert connector 110. Optionally, the device can comprise a fragrance dispenser outlet 112.

The device 100 is configured so that it can be mounted on either stanchion base barricades or non-stanchion base barricades depending upon the location. The solar power panel 102 can be configured to provide total power to the device, or supplement a battery that is used to power the device. Real-time information is displayed on the display 104 and provides the customer with appropriate communications and advertising options. The external speakers 106 can be configured to provide music, advertisements or information related to what is displayed on the display. The power harness conduit 108 provides protective covering for power based stanchions that are plugged from a base or a battery. The stanchion insert connector 110 provides the connectivity between the real-time device and the stanchion used to support device. The optional fragrance dispenser 112 can be used to provide a variety of scents that can be associated with the information being displayed on the display screen.

Referring now to FIG. 2, there is shown a rear isometric view 200 of the device of FIG. 1. As can be seen in this view, the device of FIG. 1 further comprises a power regulator 212 and one or more than one module cavity 202, 204, 206 and 208 and one or more than one keyed device input module 210. The one or more than one keyed device input module 210 can be selected from the group consisting of a contactless NFC reader board module, a processor module, a fragrance synthesizer module, a coupon module, a Wi-Fi module, a Bluetooth module and a ticketing module. The power regulator 212 can convert standard electrical power to power that can be used by the device 100 without overloading the device 100. The one or more than one module cavity 202, 204, 206 and 208 can be configured to accept keyed modules 210 that can perform various functions controlled by the device 100. The one or more than one keyed device input module 210 can be inserted into the device 100. The device 100 comprises instructions executable on a processor that will identify each of the one or more than one keyed module 210 to automatically determine the functionality of the module and how to display information related to the model on the display screen 104 to be presented to a customer. For example, the device 100 can provide a variety of scents for patrons waiting at a cosmetics counter, or tickets for a movie theater, or coupons for a grocery store. Optionally, the one or more than one keyed module 210 can comprise a contactless NFC reader board a Wi-Fi module, a Bluetooth module, an arm based computer, a fragrance synthesizer dispenser and a coupon/ticketing module.

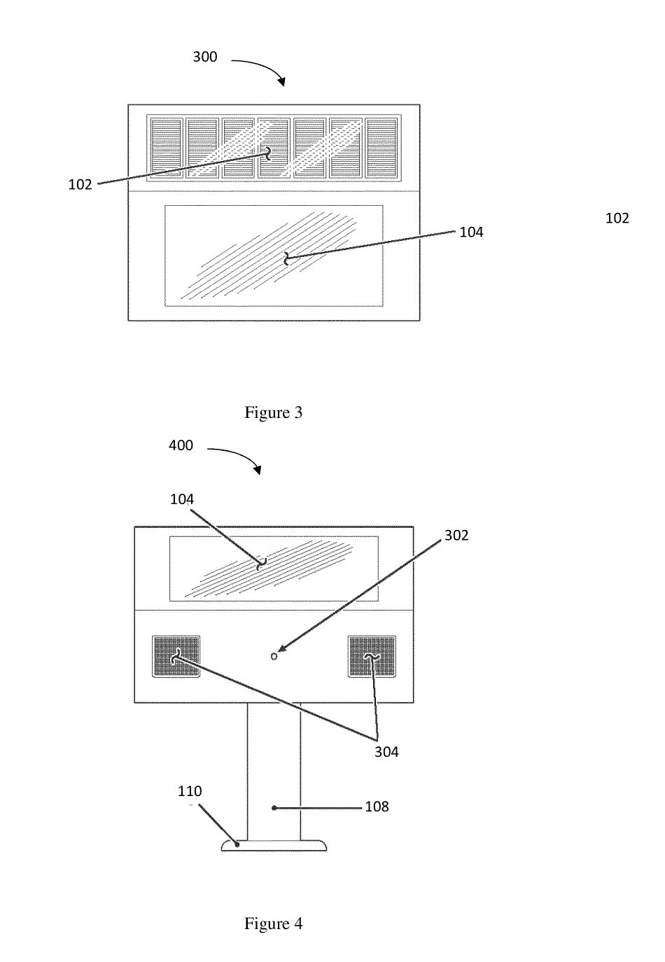

Referring now to FIG. 3, there is shown a top view of the device of FIG. 1. As can be seen the solar panel 102 and the display screen 104 can be seen. Optionally, the display screen is between 5 inches and 7.5 inches.

Referring now to FIG. 4, there is shown a front view 400 of the device of FIG. 1.

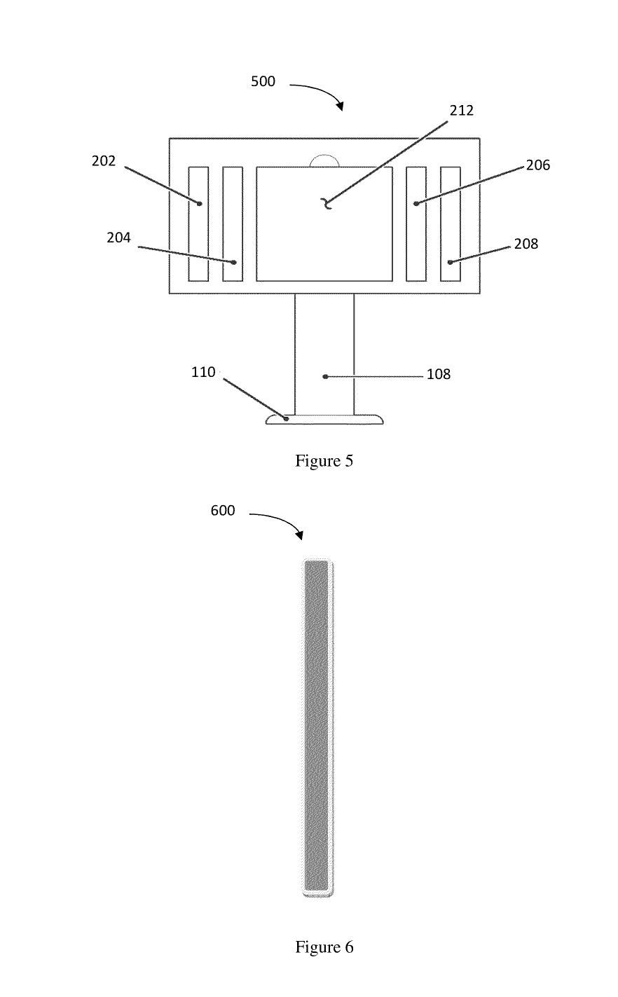

Referring now to FIG. 5, there is shown a rearview 500 of the device of FIG. 1.

Referring now to FIG. 6, there is shown a diagram of a stanchion 600 useful for the device of FIG. 1. The stanchion 600 can be used as part of the device 100 for routing power from a base through the stanchion protecting the power cable from damage and potential harm to customers.

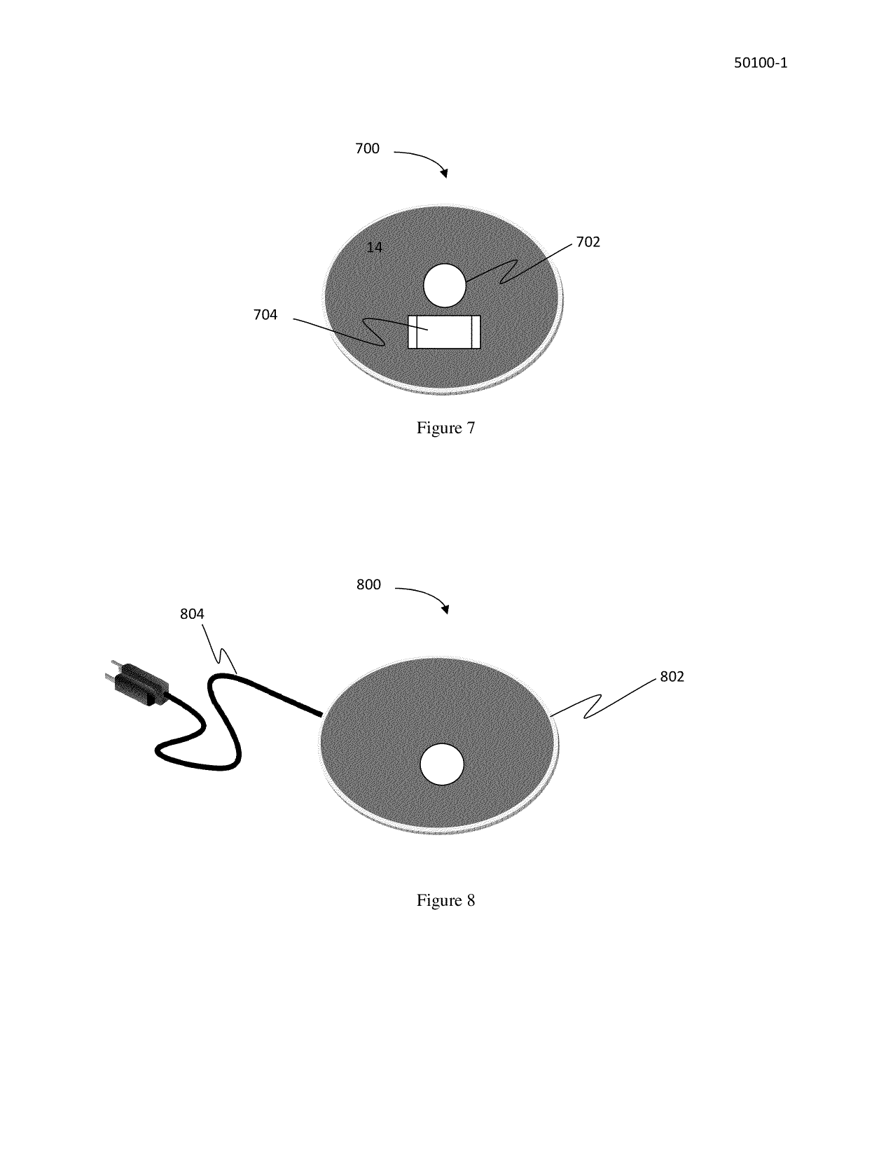

Referring now to FIG. 7, there is shown a bottom view 700 of a diagram of a base useful for the device of FIG. 1. The device 100 can optionally comprise a stanchion base, a stanchion post connector 702 and a high capacity rechargeable battery 704. In this configuration, the battery 704 that comprises the base also provides ballast for the stanchion and the device 100 to prevent the device 100 from accidentally tipping over from casual contact with the device 100 or stanchion 600. Additionally, the high capacity battery 704 can provide DC power to the device 100 for operation. This configuration is useful in locations that do not have ready access to power from an outlet, thereby making the device 100 extremely portable. In this case an optional wireless communications module can be used to provide real-time information useful to customers. The solar panel 102 can supply the battery 704 with recharging voltage to extend the life of the battery.

Referring now to FIG. 8, there is shown a top view 800 of a diagram of a base 802 useful for the device of FIG. 1. In this configuration the stanchion base 802 comprises a power cord 804. Optionally, the base 802 can comprise either a male voltage output, a female voltage input or both a male voltage output and a female voltage input. In this example, the power cord 804 voltage is shown as 220V volts, but the device 100 can be configured to use any voltage source by inserting a switching power supply module into the device 100. This makes the device 100 portable to any country or location where power is readily available. The power cord 804 connector can be configured as a standard 3-prong set with the appropriate connector for a wall socket at the location, or with any type of power cord 804 connector that is required by code at the location the device 100 is used.

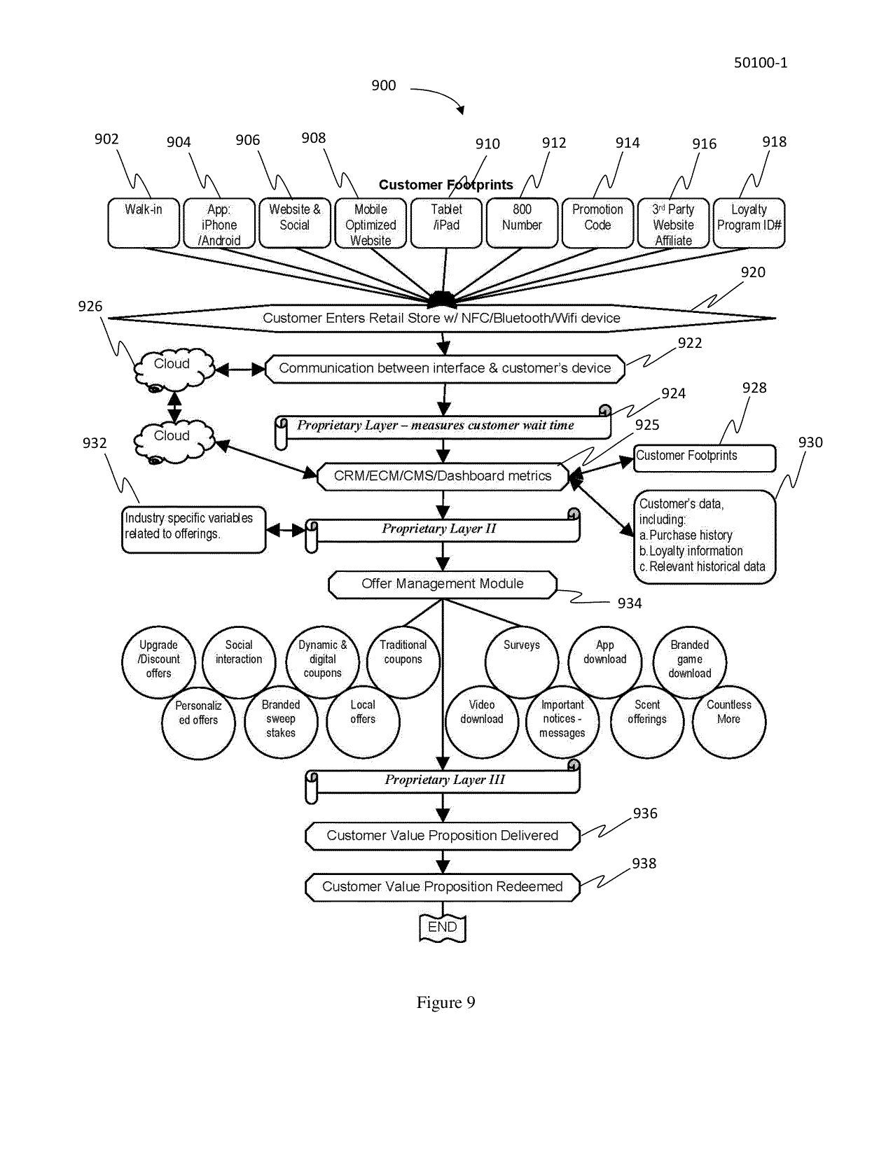

Referring now to FIG. 9, there is shown a flowchart diagram 900 of a method for using the device of FIG. 1, according to one embodiment. First, a customer establishes communications with an interactive distribution platform on the stanchion-based device 100 using one or more than one method to engage a company using one or more than one customer footprint 902, 904, 906, 908, 910, 912, 914, 916 and 918. The one or more than one customer footprint 902, 904, 906, 908, 910, 912, 914, 916 and 918 can comprise, a walk-in, a mobile application, a website, social media, a mobile website, a tablet, an 800 number, a promotion code, a third party website affiliate and a loyalty program among others. Next, the customer enters the retail store, where the store comprises wireless communications 920, such as, for example, Wi-Fi, NFC or Bluetooth. Then, the customer establishes communications 922 with a device 100. Next, the system 900 starts to measure time 924 from the establishment of communications 922 between the customer and the device 100. Then, information from the customer is transmitted 926 from the device 100 through a standard communications means to a CRM/ECM/CMS/dashboard metrics system 925 for processing. Next, the CRM/ECM/CMS/dashboard metrics system 925 can review all customer footprints 928 to find the best offer available for the customer based on previous customer data 930. The previous customer data 930 can comprise purchase history, loyalty information, and relevant historical data. Then, the system 900 can compare industry specific variables related to offerings 932 with the customer data 930. For example, the industry specific variables related to offerings 932 for the rental car industry could be fleet availability, weather and roadway information; for the airline industry, it could be seat utilization and baggage capacity; and for clothing retailers it could be excess inventory and profit margins. Next, the system 900 comprises an offer management module 934 to select a personalized offer to the customer. The offer management module 934 comprises instructions to present the customer with offers based on the customer's data 930 and the industry specific variables related to offerings 932. The offers presented to the customer can comprise upgrade offers, discount offers, social interaction, personalized offers, branded sweepstakes, dynamic and digital coupons, local offers, traditional coupons, video downloads, surveys, important notices and messages, application downloads, branded game download and scent offerings. As can be appreciated, there are many more possibilities available. The offer management module 934, can comprise instructions to offer a superset or subset of the offers. Next, the customer value proposition 936 is delivered to the customer's device. Finally, upon exiting the queue, the customer value proposition 936 can be redeemed 938.

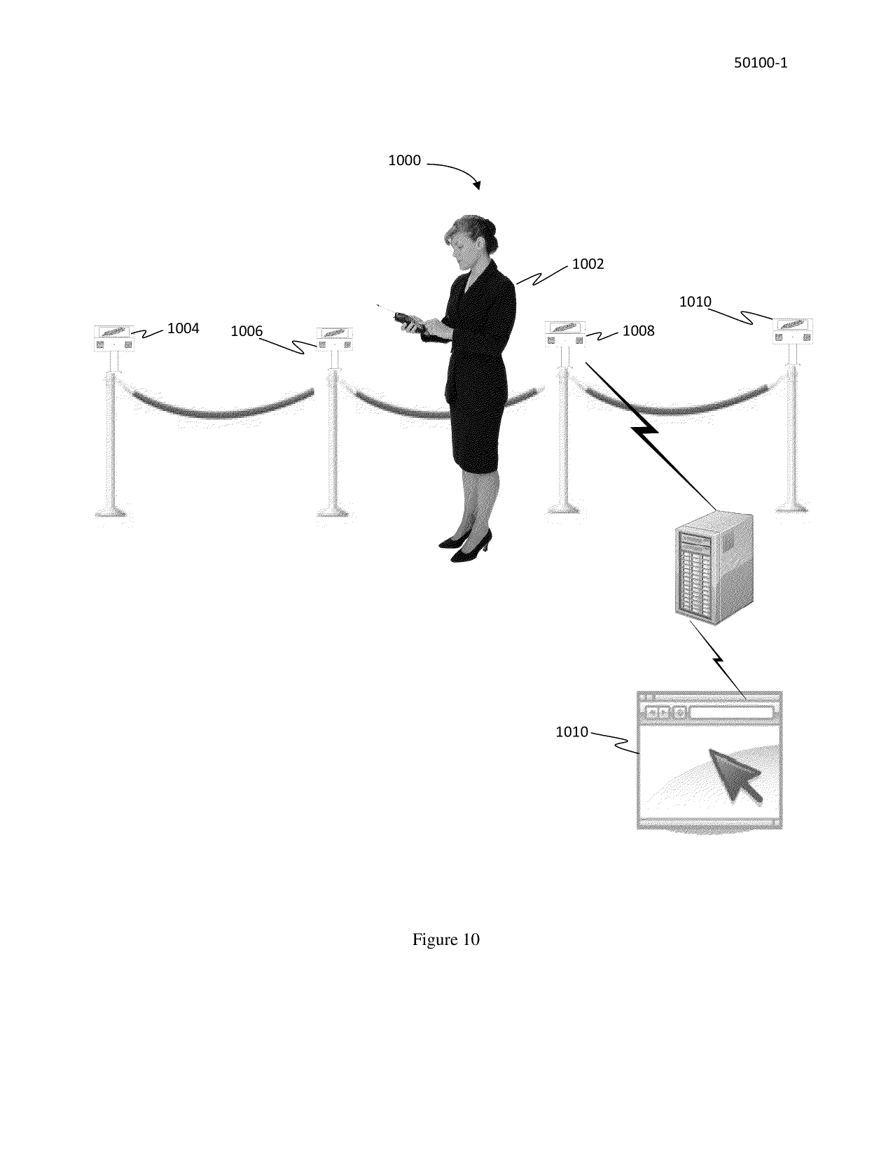

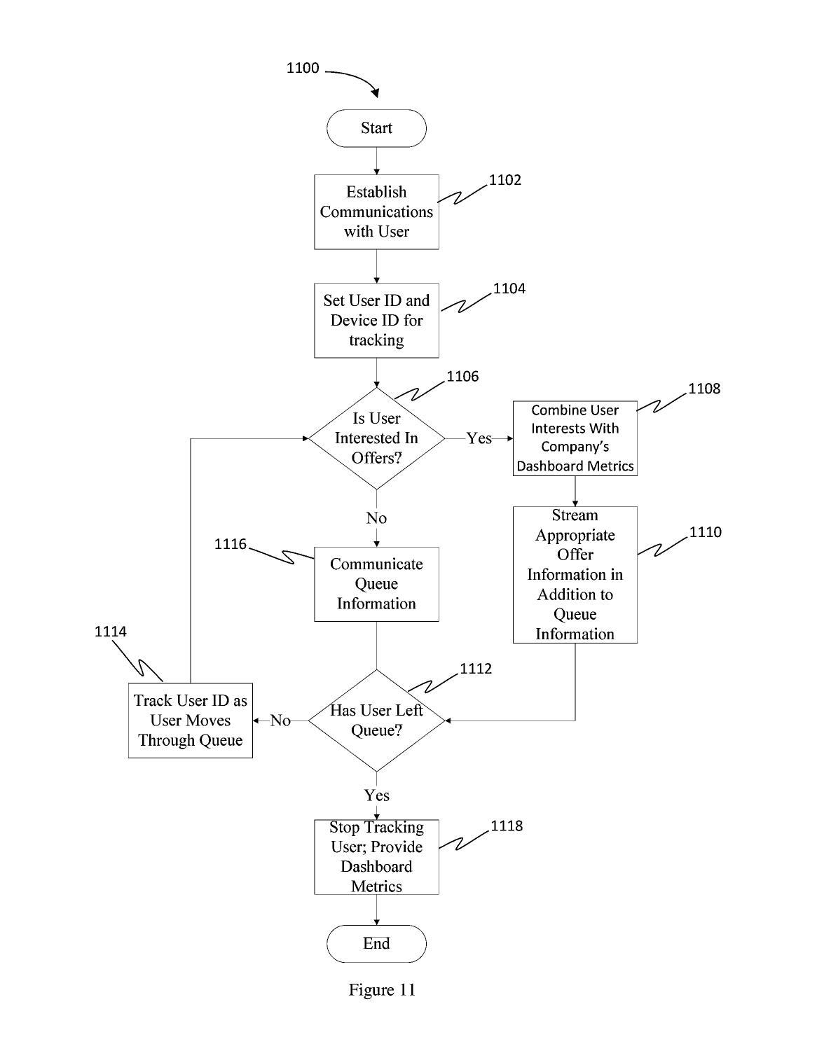

Referring now to FIG. 10, there is shown a diagram of a customer waiting to be served using the information provided by the device of FIG. 1 and the system of FIG. 9. As can be seen, as the person 1002 waits in a queue, information from the system 900 is transmitted from stanchion top devices 1004 and 1006 to the customer's 1002 portable electronic device allowing communication with the company's central server 1008. Information gathered from the customer is transmitted from the stanchion top devices 1004 and 1006 to a central server 1008 for processing and displaying dashboard metrics 1010. Pertinent offers and/or other information is transmitted to the customer 1002 who can interactively select products or be targeted for items of interest while waiting to be served. In another embodiment, one or more than one of the stanchion top devices 1004 and 1006 can comprise a computing module 210 that can execute instructions for the system 900, thereby removing the need for the central server 1008 and the displayed dashboard metrics 1010.

Referring now to FIG. 11, there is shown a flowchart diagram of another method for using the device 100. First the device 100 establishes communications 1102 with a customer. Then, a customer ID and a device 100 ID are set 1004 to track the customer through the queue. Next, a request is sent to the customer 1106 inquiring whether the customer is interested in offers. Then, if the customer is interested in offers, the customer is requested to input interests and those interests are combined with the company's dashboard metrics 1108 to personalize the offer information presented. Next, appropriate offer information and queue information (information relating to the queue the customer is waiting in) are streamed 1110 to the customer's portable electronic device. Then, a determination is made as to whether the customer is still in the queue 1112. Next, the customer ID and the device ID are tracked to determine where the customer is in the queue. If the customer is still in the queue more offers are presented until the customer leaves the queue. Finally, the customer ID and any information given by the customer is stored in a storage and the customer information is data mined 1118 for information. Alternatively, if the customer is not interested in offers 1106, only queue information is streamed to the customer. However, time metrics, such as, for example, how long the customer had to wait, can still be stored and data mined 1118.

What has been described is a new and improved system, method and device for a real-time electronic display system that is portable and mountable on a stanchion that can provide immediate information useful to a customer, overcoming the limitations and disadvantages inherent in the related art. The possibilities for the system are endless and the potential uses are equally impressive. The potential for bridging the gap between customers waiting in a queue and companies is tremendous. For example, customers waiting in queues at a rental car facility can be informed of inclement weather and be offered upgrades to all-wheel drive vehicles. Other potential benefits include:
Advertisers and Ad Agencies can present effective and creative ways to penetrate the mobile segment combining it with “base-placed” captive audiences.
Enabling the future of mobile outdoor advertising is the combination of NFC—Near Field Communication technology and deployment.
Presenting people waiting in queues with a conduit that enables them to interact with a company in a meaningful and effective way.
Using mobile adverting and base placed targeting.

Although the present invention has been described in considerable detail with reference to certain preferred versions thereof, other versions are possible. Therefore, the spirit and scope of the claims should not be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

1. A real-time electronic display device that is portable and mountable on a stanchion that can provide immediate information useful to a customer, the device comprising:
a) a housing;
b) a processor located inside the housing;
c) a solar power panel connected to the housing;
d) a digital screen connected to the housing;
e) one or more external speakers connected to the housing;
a power line harness conduit connected to the housing; and
g) a stanchion insert connector connected to the power line harness conduit.

2. The device of claim 1, further comprising a fragrance dispenser outlet connected to the housing.

3. The device of claim 1, further comprising:
a) a battery used to power the device connected to the housing;
b) a power regulator connected to the housing;
c) one or more than one module cavity connected to the housing; and
d) one or more than one keyed device input module connectable to the one or more than one module cavity.

4. The device of claim 3, where the one or more the one keyed device input module can be selected from the group consisting of a contactless NFC reader board, a Wi-Fi module, a Bluetooth module, a processor module, a fragrance synthesizer module, a coupon module, and a ticketing module.

5. The device of claim 3, where the power regulator can convert standard electrical power to power that can be used by the device without overloading the device.

6. The device of claim 3, where the one or more than one module cavity can be configured to accept keyed modules.

7. The device of claim 6, where the keyed modules can perform various functions controlled by the device.

8. The device of claim 7, where the device comprises instructions executable on the processor to identify each of the one or more than one keyed module to automatically determine the functionality of the module and how to display information related to the model on the display screen to be presented to the customer.

9. The device of claim 7, where the one or more than one keyed module can comprise a contactless NFC reader board module, an arm based computer, a fragrance synthesizer dispenser, a Wi-Fi module, a Bluetooth module and a coupon/ticketing module.

10. The device of claim 1, where the display screen is between 5 inches and 7.5 inches.

11. The device of claim 1, further comprising:
a) a stanchion connectable to the stanchion insert connector; and
b) a base connectable to the stanchion opposite the stanchion insert connector.

12. The device of claim 11, further comprising a high capacity rechargeable battery.

13. The device of claim 11, further comprising a power cord.

14. A method for using a real-time electronic display device that is portable and mountable on a stanchion that can provide immediate information useful to a customer, the method comprising the steps of:
a) entering a retail store, where the store comprises wireless communications;
b) establishing communications with a real-time electronic display device;
c) measuring a time from the establishment of communications between the customer and the device;
d) transmitting information from a customer from the device through a standard communications means to a processing system/company dashboard metrics;
e) reviewing all customer footprints available to the processing system to find the best offer available for the customer based on previous customer data;
f) comparing industry specific variables related to offerings with the previous customer data, where the industry specific variables related to offerings can comprise fleet availability, weather and roadway information, seat utilization and baggage capacity, excess inventory and profit margins;
g) determining an optimum offer for the customer;
h) preparing a personalized offer to the customer using an offer management module;
i) presenting a customer value proposition to the customer's portable electronic device; and
j) redeeming the customer value proposition by the customer upon exiting the queue.

15. The method of claim 14, where the one or more than one method of the customer's footprint comprises, a walk-in, a mobile application, a website or social media, a mobile website, a tablet, an 800 number, a promotion code, a third party website affiliate and a loyalty program.

16. The method of claim 14, where previous customer data can comprise purchase history, loyalty program, and relevant historical data.

17. The method of claim 14, where the offers presented to the customer can comprise upgrade offers, discount offers, personalized offers, social interaction, branded sweepstakes, dynamic and digital coupons, local offers, traditional coupons, video downloads, surveys, important notices, messages, application downloads, branded game download and scent offerings.

18. A method for a real-time electronic display device that is portable and mountable on a stanchion that can provide immediate information useful to a customer and company, the method comprising the steps of:
a) providing a real-time electronic display device;
b) transmitting customer information from a processing system to the real-time electronic display device and to a customer's portable electronic device;
c) transmitting information gathered from the customer from the real-time electronic display device to a central server for processing and displaying dashboard metrics for the company to analyze and manage data;
d) determining pertinent offers and other information based on the received customer information;
e) transmitting the pertinent offers and other information to the customer, where the customer can interactively select products and items of interest while waiting to be served.

19. The method of claim 18, where the real-time electronic display device comprises a computing module for executing instructions for the system without the central server.

20. A method for a real-time electronic display device that is portable and mountable on a stanchion that can provide immediate information useful to a customer, the method comprising the steps of:
a) establishing communications with a customer's portable electronic device;
b) storing a customer ID and a device ID are to track the customer's portable electronic device through the queue;
c) sending a request to the customer's portable electronic device for input from the customer regarding offers;
d) requesting customer interest input and combining it with the company's dashboard metrics;
e) streaming appropriate offer information and queue information to the customer's portable electronic device;
f) determining if the customer's portable electronic device is still in the queue;
g) tracking the customer ID and the device ID to determine a location of the customer's portable electronic device in the queue;
h) presenting more offers while the customer's portable electronic device is still in the queue;
i) storing in a storage the customer ID and any information provided by the customer; and
j) data mining the stored information.

21. The method of claim 20, further comprising the step of streaming only queue information to the customer and storing time metrics for data mining.
